(19) United States
(12) Patent Application Publication
(10) Pub. No.: US 2002/0007509 A1
(43) Pub. Date: Jan. 24, 2002

(54) Shock absorbing pad and a sportswear having the pad

(76) Inventor: Makiko Kamada, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 09/906,827

(22) Filed: Jul. 18, 2001

(30) Foreign Application Priority Data
Jul. 19, 2000 (JP) 2000-219282

(51) Int. Cl. A62B 17/00; F41H 1/00

(52) U.S. Cl. 2/455

(57) ABSTRACT

A shock absorbing pad comprises a shock resistant layer 10 and a shock absorbing layer 11 which is softer or more flexible than the shock resistant layer and arranged on the inner surface of the shock resistant layer. The shock resistant layer 10 has a convex outer surface and the shock absorbing layer 11 has a concave inner surface to define a hollow space 26 faced to the human body portion in use. The hollow space 26 allows the heat of the human body to dissipate or radiate and sweat to evaporate thereinto. The air in the hollow space 26 is expelled to outside and the outside air is introduced into the hollow space 26 by the movements of the wearer.

### FIELD OF THE INVENTION

This invention relates to a shock absorbing pad and a sportswear having the pad for a person playing with a snowboard, skateboard or mountain bicycle, or a person playing a sport, such as free skiing or bicycle motocross.

### PRIOR ART

A person handling a snowboard, skateboard or mountain bicycle, or playing a sport, such as free skiing or bicycle motocross, wears a protector for the event of falling.

A basic protector is a shock absorbing member, such as a cotton padding, worn on a human body to cover its portion to be protected.

Shock absorbing members other than a cotton padding include materials such as sponge, highly elastic rubber and a foamed resin. There are also combinations of these materials or a member having a hard skin over these materials.

There have been proposed various shock absorbing members and means for securing such a member to a human body. Japanese Patent Application Laid-Open No. 299540/1997, for example, discloses a protector (hip guard) which comprises a pad body having hip protecting portions, a coccyx protecting portion and right and left waist protecting portions extending outwardly from the hip protecting portions. The protector further has a waist band attached to the upper edge portion of the protector to be wound around the waist of the wearer and two thigh bands attached to the middle of the lower edge of the coccyx protecting portion to be passed through the crotch portion of the wearer and respectively engaged with the waist protecting portions and is secured to the human body like a diaper. The pad comprises two-layer construction which, in turn, comprises a sheet of shock absorbing material and a sheet of an elastic material such as neoprene and is covered by a front sheet and a back sheet.

Japanese Patent Application Laid-Open No. 88401/1998 discloses an inner pants for snowboarding having on inner surface thereof a pocket for holding a hip pad and pockets for holding right and left waist pads for protecting the waist. The hip pad comprises an outer layer and an inner layer of polyethylene sponge, respectively. The outer layer is harder than the inner layer so that the pad is strong against an impact exerted from outside and is tightly fitted to human body.

Japanese Patent Application Laid-Open No. 245702/1998 discloses pants for snowboarding having on the inner or outer surface thereof pockets for holding pads for protecting the knees. The knee pad is formed by foamed urethane which is superior in heat insulation and shock absorptivity.

FIG. 4 shows a shirt 16 having a front openable by a zipper 15 and provided with shoulder protecting members 17, elbow protecting members 18, arm protecting members 19 and a back protecting member 20 for protecting the back, shoulders and elbows. Each of these protecting members is formed by a highly soft or flexible padding facing the human body (a shock absorbing layer) and a relatively hard skin covering it from outside (a shock resistant layer).

FIG. 5 shows pants 21 having a coccyx protecting member 22, hip protecting members 23, thighbone protecting members 24 and pelvis protecting members 25 for protecting the body portions around the waist, mainly the hip. Each of these protecting members is formed by a single layer of a foamed plastic material. As is obvious from the drawing, the plural protecting members 22, 23, 24 and 25 are attached to the cloth of the pants 21 in a plurality of portions and spaced apart from one another so as not to hinder the motion of the waist or thighs.

### PROBLEMS TO BE SOLVED BY THE INVENTION

There is always danger in any sport played by using e.g. a snowboard and a protector is, therefore, indispensable to any player of such a sport.

The protector is required to permit the free movements of its wearer as far as possible, while being comfortable to wear.

As its wearer sweats when playing a sport, the protector is required to absorb sweat effectively, to have good ventilation for the effective dissipation of heat from the body, and to be easy to wash. It is also desirable that the protector be foldable for storage in a small space.

A known protector, for example, the one according to Japanese Patent Application Laid-Open No. 299540/1997 is something like a diaper and requires other clothing (sportswear) to be worn thereover. Its wearer is always reminded of feeling of wearing the protector (a feeling of physical disorder), and its waist or thigh bands are likely to scratch the skin.

According to Japanese Patent Application Laid-Open No. 88401/1998, the hip pad has a Y-shaped slit corresponding to the position of the joint and movements thereof and slits so as to make the pad to fit the body surface tightly, but its shock absorbing power and the ease of movements of its wearer are inversely proportional to each other, and a pad having a larger thickness produces a greater resistance to the movements of the body and a greater feeling of physical disorder.

According to Japanese Patent Application Laid-Open No. 245702/1998, the knee shock absorbing pads in the inner (or outer) pockets of the pants are adjustable in position. Each of the knee shock absorbing pads is formed by a flat sheet of a foamed urethane having high levels of heat insulating and shock absorbing properties. The pants is made by sewing a thick material including a cotton layer between an outer cloth of e.g. nylon tuft and a lining. Therefore, the pants as a whole is too bulky for storage and the cotton layer makes the pants difficult to wash. Moreover, the outlines of the flat knee pads are indecently seen from outside when the knees are bent.

The shirt shown in FIG. 4 has its protective members located at various key positions of the shirt. Each protective member is formed by a hard skin like an armor and an inner soft material, and the hard skin (17A) hindering the movements of the body is made in as small a size as possible, while the more flexible material (17B) occupies a larger area under the hard skin. The protective members for the shoulders, elbows and arms are, among others, so designed as to fit the wearer's body tightly and not to be displaced from its respective portions. The wearer, therefore, feels physical disorder when he makes a large movements in his upper arm or arms. Moreover, the shirt is worn as an underwear and requires other clothing to be worn thereover.

Each protective member attached to the outer surface of the pants shown in FIG. 5 is formed by an elastic layer having a multiplicity of holes for ventilation, a woven fabric layer covering the outer surface of the elastic layer and a ribbon hemming its edge. The elastic layer as a whole contacts the surface of the wearer's body intimately through the cloth of the pants.

It is an object of this invention to improve any known protector and to provide a pad having excellent ventilation ability and is lighter in weight without lowering its shock absorbing power and a sportswear having such a pad.

### MEAN FOR SOLVING THE PROBLEMS

The above object is attained by a shock absorbing pad comprising a shock resistant layer and a shock absorbing layer which is softer or more flexible than the shock resistant layer and arranged on the inner surface of the shock resistant layer, the shock resistant layer having a convex outer surface, while the shock absorbing layer having a concave inner surface to define a hollow space faced in use to a human body to be protected. A hemming fabric is preferably employed for securing the outer reinforcing fabric to the shock resistant layer. The hemming fabric may have one edge attached to the upper surface of the outer reinforcing fabric along its outer edge portion and another edge attached to the lower surface of the shock resistant layer along its outer edge portion to form a hemmed outer edge for a two-layer portion formed by the outer reinforcing fabric and the shock resistant layer.

### BRIEF DESCRIPTION OF THE DRAWINGS

FIG. 1(a) is a schematic cross-sectional view of a shock absorbing pad according to this invention, and FIG. 1(b) is a schematic bottom plan view thereof.

FIG. 2(a) is a schematic front elevational view of a sportswear (shirt) carrying on its outer surface a plurality of shock absorbing pads each having the structure as shown in FIG. 1 and having a contour suited for the human body portion to be protected, and FIG. 2(b) is a schematic rear elevational view thereof.

FIG. 3(a) is a schematic front elevational view of a sportswear (pants) having the same characteristics as the wear shown in FIG. 2, and FIG. 3(b) is a schematic rear elevational view thereof.

FIG. 4(a) is a schematic front elevational view of a known protector (for the upper half of the body), and FIG. 4(b) is a schematic rear elevational view thereof.

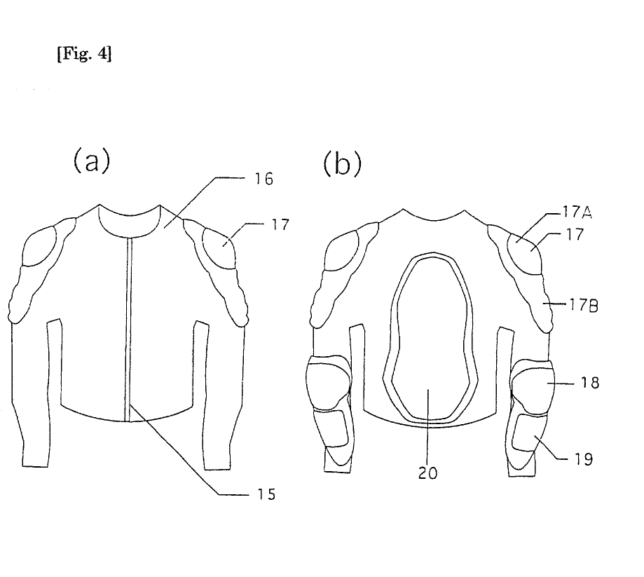

FIG. 5 is a schematic rear elevational view of another known protector (around the waist).

### MODES OF EMBODYING THE INVENTION

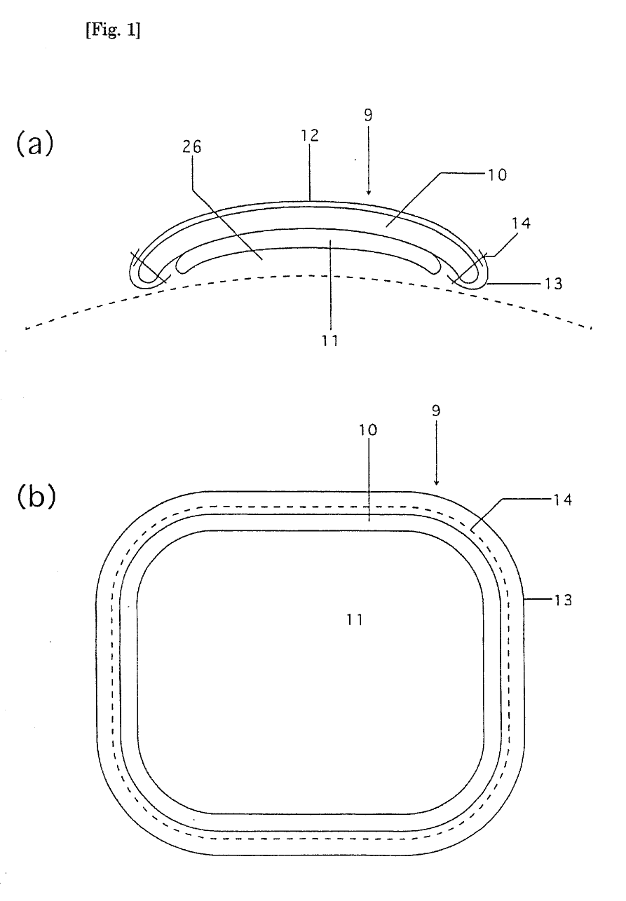

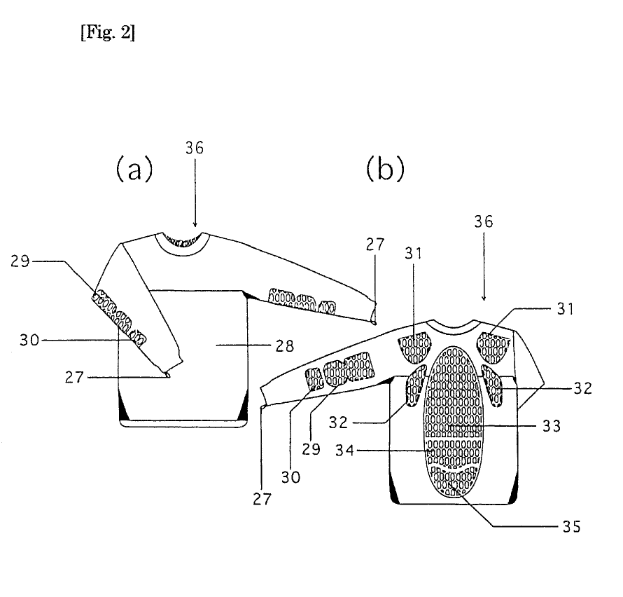

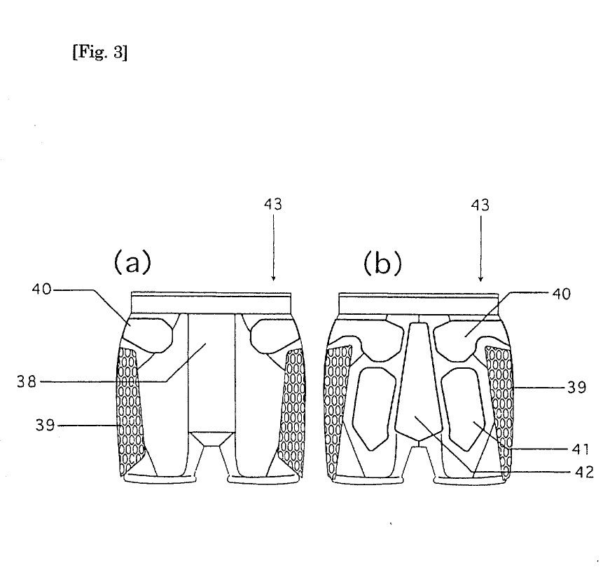

FIG. 1 shows a shock absorbing pad having a nearly square contour but actual shock absorbing pads may have various complicated contours as shown in FIGS. 2 and 3. Each shock absorbing pad is formed basically by two functional layers, i.e. a shock resistant layer and a shock absorbing layer, both of a foamed plastic material, and the shock resistant layer has a convex outer surface, while the shock absorbing layer has a concave inner surface so that its concave surface and a human body surface may define a hollow space therebetween.

The shock resistant layer is made of a foamed plastic material and is sufficiently hard to repulse impact. The shock absorbing layer is also made of a foamed plastic material and is sufficiently soft or flexible to absorb impact.

The outer reinforcing fabric may, for example, be a woven fabric. The outer reinforcing fabric protects the surface of the shock resistant layer when the pad contacts the ground with impact. Without the outer reinforcing fabric, the surface of the shock resistant layer will be damaged. The outer reinforcing fabric promotes the sliding of the pad to relieve it from impact resulting from its contact with the ground and protect the surface of the shock resistant layer from being damaged. Therefore, it is possible to design a sportswear having on its outer surface a shock absorbing pad according to this invention as an outer wear.

The outer reinforcing fabric may be secured to the shock resistant layer by extending its outer edge to project beyond the outer edge of the shock resistant layer, folding the projected outer edge onto back side of the shock resistant layer and adhering or fusing the same to the back side of the shock resistant layer. Alternatively, the portion of the outer reinforcing fabric as folded onto the back side of the shock resistant layer and the front side of the outer reinforcing fabric may be sewn together by e.g. a sewing machine with the shock resistant layer being interposed therebetween.

A hemming fabric may be used as another means for fastening the outer reinforcing fabric to the shock resistant layer. It may, for example, be a woven fabric and form a hemmed edge for the outer reinforcing fabric and the shock resistant layer.

The shock absorbing pad may be attached to a knitted cloth of wear made from yarns of polyester fiber and capable of absorbing sweat and drying quickly.

The pad may be sewn along its edge to the outer surface of a knitted cloth of wear, whereby the shock resistant layer is secured along its edge to the outer surface of the wear.

The pad may alternatively be fitted removably in a pocket formed in the wear.

The shock resistant and absorbing layers of the pad may have an appropriate number of holes for ventilation.

[Embodiments]

Description will now be made in detail of the basic structure of the shock absorbing pad according to this invention and two examples of sportswear having such shock absorbing pads with reference to FIGS. 1 to 3.

FIG. 1(a) is a schematic cross-sectional view of a shock absorbing pad according to this invention and FIG. 1(b) is a rear view thereof.

In the drawings, the reference numeral 10 designates a shock resistant layer of a foamed plastic material, 11 a shock absorbing layer of a foamed plastic material having a smaller area than the shock resistant layer and a contour similar to that of the shock resistant layer, 12 an outer reinforcing fabric, 13 a hemming fabric, 14 a stitch and 26 a hollow space.

The shock resistant layer 10 is a foamed product of an ethylene-vinyl acetate copolymer (EVA) having a volume 10 to 15 times larger than its original volume and having a thickness and a hardness which enable it to spring back or repulse impact upon receiving the impact. EVA is, however, not the only material, but may be replaced by other appropriate foamed plastic having a reasonable degree of foaming, e.g. an polypropylene or an appropriate polyurethane foam. It is unnecessary that the shock resistant layer be a single layer of a foamed plastic material but may alternatively be a composite layer of different kinds of foamed plastic materials. Moreover, it may be a layer of a rubber foam, sponge or a combination of materials as mentioned above.

The shock absorbing layer 11 is a foamed product of EVA having a volume about 30 times larger than its original volume and is sufficiently soft or flexible and thick to absorb impact. EVA is, however, not the only material but may be replaced by other appropriate foamed plastic having a reasonable degree of foaming, e.g. polypropylene or polyurethane foam. It is unnecessary that the shock absorbing layer be a single layer of foamed plastic material but may alternatively be a composite layer of different kinds of foamed plastic materials. Moreover, it may be a layer of a rubber foam, sponge or a combination of materials as mentioned above.

The outer reinforcing fabric 12 can protect the surface of the shock resistant layer effectively at the time of its contact with the ground with impact, even if it is a meshed fabric.

The outer reinforcing fabric 12 has the same size as the shock resistant layer 10. The hemming fabric 13 forms a hemmed edge for these two layers. The hemming fabric may be a woven one, too. The hemming fabric (or ribbon) is bent along its longitudinal centerline so as to form a hem by interposing between the folded portions of the hemming fabric the outer edge portions of the shock resistant layer 10 and the outer reinforcing fabric 12. The hem is completed by e.g. sewing as shown by a stitch 14, whereby the outer edge portion of the outer reinforcing fabric 12 is joined to the edge portion of the shock resistant layer 10.

The outer reinforcing fabric can, however, have its edge portion joined to the edge portion of the shock resistant layer directly by fusion or adhesion without the aid of any hemming fabric. The outer reinforcing fabric may alternatively have its outer edge portion extended to the back side of the shock resistant layer and sewn by e.g. sewing machine to tuck the shock resistant layer.

The shock resistant layer 10 has a hardness which enables it to repulse the impact, and such a hardness may be attained by a foamed product of EVA having a volume 10 to 15 times larger than its original volume and a thickness of about 5 mm. The shock resistant layer 10 has a convex outer surface so that the shock absorbing layer 11 may define a hollow space 26 on its inner surface side. Its convex surface can be formed by forming the shock resistant layer in a mold. It is alternatively possible to employ, for example, a flat disk of a foamed plastic material, to form an adequate number of radially inwardly tapered cutouts extending from its periphery and to close the cutouts together by adhesion or fusion to thereby transform the disk into a convex shape as desired.

The shock absorbing layer 11 is secured on the inner surface of the shock resistant layer 10. The shock absorbing layer 11 has a softness or flexibility and a thickness which enable it to absorb impact, and which may be attained by a foamed product of EVA having a volume about 30 times larger than its original volume and a thickness of about 8 mm. The shock absorbing layer 11 has a concave inner surface extending along the shock resistant layer 10. Its concave surface is so curved as to define the hollow space 26 between the shock absorbing layer and the surface of a human body portion when the pad has been placed in faced relation to the desired portion of the human body.

The air contained in the hollow space 26, in addition to the shock absorbing by the shock resistant and shock absorbing layers 10 and 11, absorbs impact with which the pad contacts the ground by being compressed in the hollow space 26. This makes possible to make smaller the thickness and weight of the layers 10 and 11. Furthermore, the hollow space 26, contrary to the prior arts, allows the heat of the human body to dissipate or radiate and the sweat to evaporate thereinto respectively. The air in the hollow space 26 will be expelled to outside and the outside air will be introduced into the hollow space 26 by the movements of the wearer through the periphery of the pad.

In the case wherein ventilation holes are formed through the shock resistant layer 10 and shock absorbing layer 11, the air inside the hollow space 26 will be expelled to outside and the outside air will be introduced into the hollow space 26 also through the ventilation holes, promoting heat dissipation or radiation from the human body and evaporation of sweat though the shock absorbing ability of the hollow space 26 will be lowered or might be substantially nullified depending on the number and size of the ventilation holes.

Owing to the two functional layers, i.e. the shock resistant layer 10 and the shock absorbing layer 11 arranged inwardly of the shock resistant layer and having a smaller contour, the shock absorbing pad well fits the human body along its edge portion and confines air effectively in the hollow space 26 when the pad contacts the ground to perform an effective shock absorbing action. The two layers may be formed materials foamed to appropriately selected degrees and thereby enable the pad to have a small thickness and a light weight.

The shock absorbing pad 9 is usually attached directly to the outer surface of a sportswear serving also as outer clothing. It can be attached by sewing its edge portion to the cloth of the sportswear. Its sewing may give a stitch in the form of a loop surrounding the loop of the stitch 14 shown in FIG. 1(b) and extending substantially in parallel to the stitch 14. It is alternatively possible to form in the cloth of sportswear an opening somewhat smaller than the pad 9 and sew the pad 9 to the inner surface of the sportswear so that substantially the whole of the pad 9 is exposed through the opening. The pad 9 may alternatively be sewn to the outer surface of the sportswear so as to close the opening.

FIG. 2 shows sportswear (particularly for a snowboarder) having shock absorbing pads each having the basic structure as shown in FIG. 1. It is worn as an outer clothing.

FIG. 2(a) is a schematic front elevational view of the sportswear (shirt) and FIG. 2(b) is a schematic rear elevational view thereof. In these drawings, the reference numeral 28 designates a knitted round-neck shirt, 29 shock absorbing pads for elbows, 30 shock absorbing pads for arms, 31 shock absorbing pads for shoulder blades, 32 shock absorbing pads for back ribs, 33 a shock absorbing pad for the thoracic vertebrae, 34 a shock absorbing pad for the lumbar, a shock absorbing pad for the coccyx and 27 thumb hooks (loops).

The sportswear 36 worn as an outer clothing is likely to have its sleeves twisted during exercise and thereby cause the shock absorbing pads for elbows and arms to displace away from their predetermined positions when contacting the ground with impact. Therefore, the sleeves have the loops 27 fastened to their ends. The insertion of the thumbs through the loops 27 makes it very easy to prevent the sleeves from being twisted or slipping up on the arms.

The sportswear 36 enables its wearer to easily enjoy a sport, such as snowboarding since it is a round-neck shirt which he can put on by slipping it over his head, though it carries many shock absorbing pads.

The sportswear 36 does, however, not necessarily have to carry so many shock absorbing pads as shown in FIG. 2 but may have only a smaller number of pads depending on whether its wearer is an elementary, intermediate or advanced player.

FIG. 3 shows another form of sportswear embodying this invention. It is worn as a hip guard (particularly for a snowboarder).

FIG. 3(a) is a schematic front elevational view of the sportswear (pants) and FIG. 3(b) is a schematic rear elevational view thereof. In these drawings, the reference numeral 43 designates a sportswear (pants) serving as a hip guard for a snowboarder 38 a knit pants, 39 shock absorbing pads for protecting the thighbones, 40 shock absorbing pads for protecting the pelvises on both sides of the waist, 41 shock absorbing pads for protecting the hip and 42 a shock absorbing pad for protecting the coccyx.

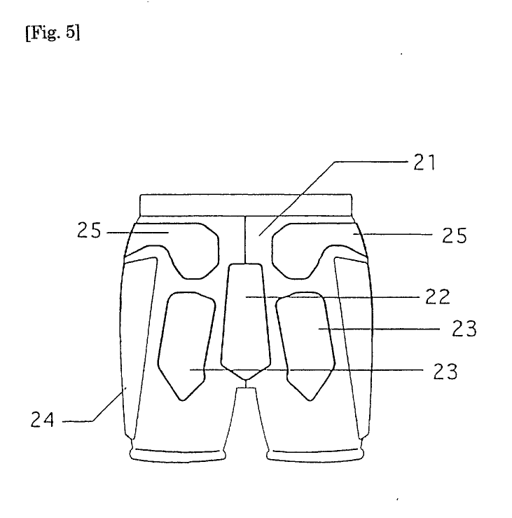

The sportswear 43 serving also as a hip guard may appear to be the same as the hip guard (pants 21) shown in FIG. 5. The shock absorbing pads of the sportswear 43 serving also a hip guard, however, have characteristic feature shown in FIG. 1 and each pad encloses a hollow space 26 which lets air to move thereinto and thereout by the movements of the wearer. The shock absorbing pads according to this invention are softer or more flexible than the foamed plastic layers forming the protective members 22 to 25 shown in FIG. 5 and exhibit a more effective shock absorbing function.

The shock absorbing pad of this invention may be designed for a nice and smart appearance, as well as for an excellent function because it can be attached to the outer surface of sportswear. Accordingly, the pad can create a new fashion for sportswear. For example, it will be possible to give an appropriate color to the shock resistant layer, to form the reinforcing fabric covering the shock resistant layer as a mesh having an appropriate opening and to color it differently from the shock resistant layer. Thus the wear may look differently colored according to the angle at which it is seen. Moreover, the hemming fabric may also be appropriately colored to make the wear more colorful.

### Advantages brought about by the Invention

(1) The shock absorbing pad of this invention is easy to wash and dry since it is basically of a foamed plastic material.

(2) The pad of this invention has an improved ventilation since its hollow space facing the body of its wearer lets air to move thereinto and thereout according to the movements of his body.

(3) The pad is smaller in thickness than its equivalents known in the art and yet functions more effectively since the air in its hollow space is compressed and released from its periphery when the wearer has received an impact on his body.

(4) The pad has a small thickness which enables the sportswear to occupy only a small space for storage.

(5) The reinforcing fabric on the shock resistant layer of the pad according to this invention allows the pad to slide to some extent upon contacting the ground to thereby provide a relief for the impact acting upon it.

(6) The pad makes it possible to use the sportswear as an outer clothing since the reinforcing fabric prevents the surface of the shock resistant layer from being damaged upon contacting the ground. This means a reduction in weight of the equipment to be carried by its wearer.

(7) The pad is less likely to hinder the movements of the human body than any known protector since the two functional layers thereof have a combined thickness which is smaller than the thickness of a single foamed plastic layer forming any known protector, and since the pad does not have any hard skin.

What is claimed is

1. A shock absorbing pad to protect a desired human body portion to be protected, characterized by that the pad comprises a shock resistant layer and a shock absorbing layer which is softer or more flexible than the shock resistant layer and arranged on the inner surface of the shock resistant layer, and that the shock resistant layer has a convex outer surface, while the shock absorbing layer has a concave inner surface to define a hollow space facing to said human body portion in use.

2. A shock absorbing pad according to claim 1, wherein the shock resistant layer and the shock absorbing layer have holes for ventilation communicated with the hollow space.

3. A shock absorbing pad according to claim 1 or 2, wherein the pad further comprises an outer reinforcing fabric covering the outer surface of the shock resistant layer.

4. A shock absorbing pad according to any one of claims 1-3, wherein the shock resistant layer and the shock absorbing layer are made of a foamed material.

5. A shock absorbing pad according to claim 4, wherein the foamed material is a foamed plastic material.

6. A shock absorbing pad according to claim 5, wherein the foamed plastic material is foamed ethylene-vinyl acetate copolymer.

7. A shock absorbing pad according to claim 6, wherein the degrees of foaming of the ethylene-vinyl acetate copolymer are 10-15 times and about 30 times, respectively, of the original volume.

8. A shock absorbing pad according to claim 3, wherein the shock absorbing layer has a smaller area than the shock resistant layer, and the outer edge portions of the shock resistant layer and the outer reinforcing fabric are hemmed by means of a hemming fabric having its opposite edge portions sewn together through the shock resistant layer and the outer reinforcing fabric.

9. A sportswear characterized by that at least one shock absorbing pad according to any one of claims 1-8 is sewn along its outer edge portion to the cloth of the sportswear correspondingly to the desired human body portion to be protected.

10. A sportswear characterized by that at least one shock absorbing pad according to any one of claims 1-8 is attached at least to the elbow portion of each cylindrical sleeve of the sportswear and a thumb hook is provided at the edge end of each sleeve.

11. A sportswear according to claim 9 or 10, wherein the cloth of the sportswear is a knit capable of absorbing sweat and drying quickly.
